(19) United States
(12) Patent Application Publication
(10) Pub. No.: US 2010/0328388 A1
(43) Pub. Date: Dec. 30, 2010

(54) INKJET PRINTER, INKJET PRINTING METHOD AND PROGRAM

(75) Inventors: Rie Takekoshi, Kawasaki-shi (JP); Takao Ogata, Tokyo (JP); Noboru Kunimine, Tokyo (JP)

Correspondence Address: FITZPATRICK CELLA HARPER & SCINTO, 1290 Avenue of the Americas, NEW YORK, NY, 10104-3800, US

(73) Assignee: CANON KABUSHIKI KAISHA, Tokyo (JP)

(21) Appl. No.: 12/818,526

(22) Filed: Jun. 18, 2010

(30) Foreign Application Priority Data
Jun. 25, 2009 (JP) 2009-151072

(51) Int. Cl. B41J 29/38

(52) U.S. Cl. 347/14

(57) ABSTRACT

The present invention ejects a treatment liquid at a scan before a scan where ink is ejected and reduces variations in a time interval from a point of the ejection of the treatment liquid to a point of the ejection of the ink, thereby enabling an increase in image performance, and longevity, low costs and reduction in size of the print head. For achieving this object, the present invention includes a treatment liquid ejection data generating unit configured to generate the treatment liquid ejection data for ejecting the treatment liquid from the print head to the unit area before the formation of the image by the ink starts. The treatment liquid ejection data generating unit generates the treatment liquid ejection data in such a manner as to eject the treatment liquid at the plural times of the scans of the print head.

### BACKGROUND OF THE INVENTION

1. Field of the Invention

The present invention relates to an inkjet type printer which uses a print head that ejects ink and treatment liquid, the print head scanning a predetermined area of a print medium a plurality of times to form an image within the predetermined area.

2. Description of the Related Art

Recently inkjet printers have been widely used from office applications such as photos, posters and CAD drawings to public exhibition applications or commercial print applications as a result of high-resolution and speeding-up of a print image. A print medium used for such various applications includes various types of mediums from inexpensive plain paper to expensive graphic glossy paper, and as to the image, there is a demand of increasing image quality such as high-resolution or high coloring performance or a demand of increasing image robustness such as water resistance or highlighter blur resistance.

A color print in the inkjet printer expresses various colors by ejecting color ink such as yellow, cyan and magenta onto the same pixel of the print medium. Since the plural colors of ink are ejected onto the print medium substantially simultaneously, it is necessary to use a fine coating paper or coating paper of which absorption characteristics are adjusted to be improved by applying special treatment on a surface of the print medium for meeting the above demand. In using a non-coating paper such as inexpensive plain paper, however, ink having relatively high permeability is required to be used.

For example, in a case of performing a color print on a plain paper, ink having high permeability is used for each color ink. However, the ink having the high permeability is low in edge sharpness expressing a blur degree of a boundary between print portions and an optical density value (OD value) thereof tends to be lowered. In a case of performing a print only in black color such as characters, since a contour of the character is blurred and coloring of the black color becomes unclear in the ink having the high permeability, print quality of the character is degraded as compared to ink having low permeability. For solving this problem, some of conventional technologies adopt a method in which a treatment liquid reacting with ink is applied on a print medium without use of the ink with the high permeability. According to this method, the treatment liquid reacting with ink is applied on the print medium before applying ink containing a color material thereon, and as a result of reaction between the ink and the treatment liquid, fixation performance of the ink in the print medium is enhanced.

Japanese Patent Laid-Open No. H11-268260 (1999), as a method of thus using the treatment liquid, discloses a technology in which two print heads for treatment liquid are arranged in both sides of a print head for color ink. In addition, Japanese Patent Laid-Open No. H08-281933 (1996) discloses a system of sandwiching treatment liquid dots with ink dots.

In the system disclosed in Japanese Patent Laid-Open No. H11-268260 (1999), the print head for treatment liquid to be used is selected corresponding to the scan direction of the print head performing a reciprocal scanning operation in such a manner that the treatment liquid is applied on the print medium before applying the color ink thereon. According to this system, in both of the forward scanning operation and the backward scanning operation of the print head, it is possible to apply the treatment liquid on the print medium before applying the color ink thereon. Therefore, as compared to a one-way print in which the print head for treatment liquid is provided only at one side of the print head for color ink and the print can be performed only in the direction where the print head for treatment liquid always goes ahead, the speeding-up of the print can be carried out. However, since the apparatus disclosed in Japanese Patent Laid-Open No. H11-268260 (1999) needs use of the two print heads for treatment liquid, it creates a possibility of leading to an increase in size and cost of the apparatus.

On the other hand, as shown in Japanese Patent Laid-Open No. H08-281933 (1996), according to the system of sandwiching the treatment dots with the ink dots, after performing a print in color ink, the treatment liquid is applied at least one time to an area where the color ink is printed and a print is performed in color ink once again to the area where the treatment liquid has been applied. In this system, since the print direction is limited to one way, it is possible to achieve the speeding-up. Further, by dispersedly arranging a pixel where the ink dot overlaps on the treatment liquid and a pixel where the treatment liquid dot overlaps on the ink dot, it reduces a problem that the color unevenness due to a difference in coloring characteristic between both the pixels adversely affects an image.

The technology disclosed in Japanese Patent Laid-Open No. H08-281933 (1996) described above is designed to macroscopically improve a difference in coloring between both the pixels due to a difference in the overlap order of the treatment liquid dot and the ink dot, by the arrangement of each of the dots. However, in the printing system of Japanese Patent Laid-Open No. H08-281933 (1996), since the treatment liquid is ejected from nozzles of the print head only at an initial scan, the nozzles used for ejecting the treatment liquid become primarily those in a particular range. Therefore, durability of the print head for treatment liquid is possibly damaged.

### SUMMARY OF THE INVENTION

An object of the present invention is to provide a printer which can perform ejection of a treatment liquid at a scan before a scan at which ink is first ejected.

For achieving the above object, the present invention has the following configuration.

Specifically, according to a first aspect of the present invention, the present invention provides an inkjet printer in which a print head ejecting ink and a treatment liquid is used, the print head scans a unit area on the print medium by plural times, the ink is ejected to the unit area based upon ink ejection data and the treatment liquid is ejected to the unit area based upon the treatment liquid ejection data, thus performing formation of an image, the inkjet printer comprising: a treatment liquid ejection data generating unit configured to generate the treatment liquid ejection data for ejecting the treatment liquid from the print head to the unit area before the formation of the image by the ink starts; wherein the treatment liquid ejection data generating unit generates the treatment liquid ejection data in such a manner as to eject the treatment liquid at the plural times of the scans of the print head.

According to a second aspect of the invention, the present invention provides an inkjet printing method that a print head ejecting ink and a treatment liquid is used, the print head scans a unit area on the print medium by plural times, the ink is ejected to the unit area based upon ink ejection data and the treatment liquid is ejected to the unit area based upon the treatment liquid ejection data, thus performing formation of an image, the inkjet printing method comprising: a treatment liquid ejection data generating step of generating the treatment liquid ejection data for ejecting the treatment liquid from the print head to the unit area before the formation of the image by the ink starts, wherein the treatment liquid ejection data generating step generates the treatment liquid ejection data in such a manner as to eject the treatment liquid at the plural times of the scans of the print head.

The present invention can generate the ejection data for ejecting the treatment liquid based upon the ejection data of the ink, at the scan before the scan at which the ink is first ejected.

Further features of the present invention will become apparent from the following description of exemplary embodiments (with reference to the attached drawings).

### BRIEF DESCRIPTION OF THE DRAWINGS

FIG. 1 is a perspective view showing an arrangement of a carriage and a portion close thereto in an inkjet printer to which the present invention is applicable;

FIG. 2 is a bottom view showing a print head shown in FIG. 1 as viewed from an ejection opening side thereof;

FIG. 3 is a view showing a system of the inkjet printer according to the present invention;

FIG. 4 is a block diagram showing a schematic configuration of an image processing unit shown in FIG. 3;

FIG. 5 is an explanatory view showing a printing method in a first embodiment of the present invention;

FIG. 6 is an explanatory view showing an ejection pattern of a treatment liquid stored in pattern unitmemory unit shown in FIG. 4;

FIG. 7 is an explanatory view showing an arrangement of dots formed of cyan ink and magenta ink;

FIGS. 8A to 8D are explanatory views showing ejection data of the cyan ink from a second scan to a fifth scan shown in FIG. 5;

FIGS. 9A to 9D are explanatory views showing ejection data of the magenta ink from the second scan to the fifth scan shown in FIG. 5;

FIGS. 10A to 10D are explanatory views showing ejection data of the cyan ink and the magenta ink from the second scan to the fifth scan shown in FIG. 5;

FIG. 11 is an explanatory view showing the scan numbers at an image forming start corresponding to the ejection data in FIGS. 10A to 10D;

FIG. 12 is an explanatory view showing data found by subtracting “one” from each of numerical values shown in FIG. 11;

FIG. 13 is an explanatory view showing data found by a logical addition of the ejection pattern shown in FIG. 6 and the data shown in FIG. 12;

FIGS. 14A to 19D are explanatory views showing ejection data of the treatment liquid from the first scan to the fourth scan shown in FIG. 5;

FIG. 15 is an explanatory view showing a printing method in a second embodiment of the present invention;

FIGS. 16A to 16D are explanatory views each showing a mask pattern for ejection data of the cyan ink;

FIGS. 17A to 17D are explanatory views each showing a mask pattern for ejection data of the magenta ink;

FIG. 18 is an explanatory view showing a pattern in a combination of the mask pattern for the second scan shown in FIG. 16 and the mask pattern for the second scan shown in FIG. 17;

FIGS. 19A and 19B are explanatory views each showing a mask pattern for ejection data of the treatment liquid at each of the first scan and the second scan;

FIG. 20 is an explanatory view showing an arrangement of dots formed by the cyan ink or the magenta ink;

FIGS. 21A and 21B are explanatory views each showing data found by a logical multiplication of the dot arrangement shown in FIG. 20 and the mask pattern shown in FIG. 19;

FIGS. 22A to 22D are explanatory views showing ejection data of the treatment liquid from the first scan to the fourth scan found by a logical multiplication of the ejection pattern shown in FIG. 6 and the data shown in FIG. 21;

FIG. 23 is an explanatory view showing a range of use nozzles in a print head according to a printing method in a comparative example to the present invention;

FIG. 29 is a view showing a schematic configuration of an inkjet printing system to which the present invention is applicable;

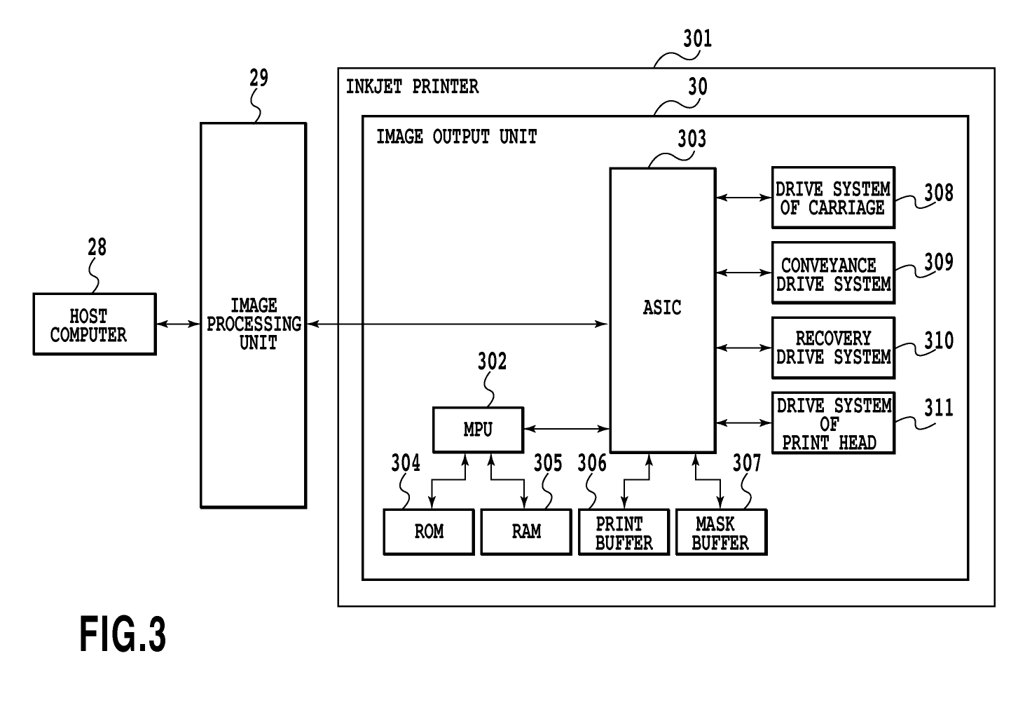

FIG. 25 is a block diagram showing a schematic configuration in a third embodiment of the present invention in regard to the image processing unit shown in FIG. 3;

FIG. 26 is an explanatory view of a second print system in the third embodiment of the present invention; and

FIG. 27 is an explanatory view of a relation between first and second print operations in the third embodiment of the present invention.

### DESCRIPTION OF THE EMBODIMENTS

Hereinafter, embodiments of the present invention will be explained.

In the present specification, “ink” denotes a liquid containing a color material for applying a black color and other colors on a print medium. In addition, “treatment liquid” is a liquid which gets in contact with ink to act on the ink and denotes a liquid (image-performance improving liquid) for improving image performance such as image quality or image robustness, and further includes a liquid containing a component having a function for insoluble or cohesion of color materials in the ink. Here, “improvement on image robustness” unit to improve at least one of a water resistance, an alkali resistance, a highlighter-blur resistance and fixation properties of a printed image for improving robustness of a color ink image. On the other hand, “improvement on image quality” unit to improve at least one of coloring (density) and character sharpness of the printed image for improving quality of the color ink image.

Hereinafter, with reference to the drawings, preferred embodiments of the present embodiments will be explained in detail.

### 1. First Embodiment

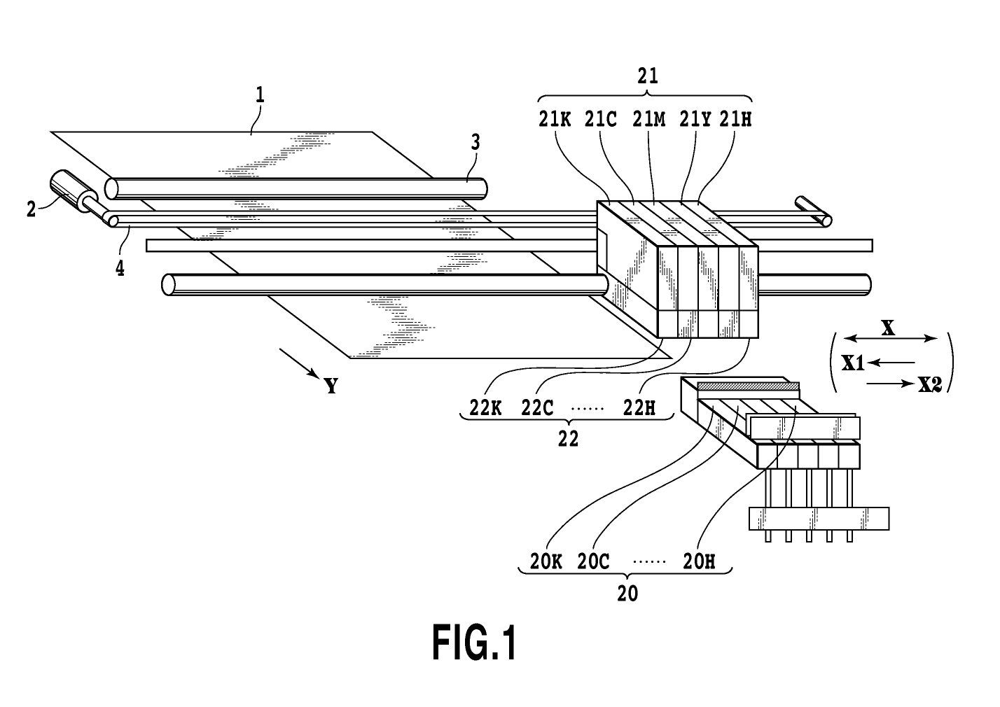

FIGS. 1 to 14 are views explaining a first embodiment of the present invention. Hereinafter, the first embodiment will be explained separately for each item of “Compositions of Color Ink and Treatment Liquid”, “Configuration of Printer”, “Configuration of Image Processing System”, “Print Operation” and “Method of Generating Ejection Data of Treatment Liquid”.

### [Compositions of Color Ink and Treatment Liquid]

Compositions of color ink and treatment liquid used in the present embodiment will be explained.

(1) Production of Treatment Liquid

A treatment liquid was produced by mixing and dissolving the following components, thereafter was pressurized and filtered through a membrane filter (Trade name: Fluoro pore filter made by Sumitomo Electric Industries Co., Ltd.) having a pore size of 0.22 μm, and then pH thereof was adjusted to 9.8 with NaOH.

| | |
|---|---|
| Low molecular component of a cationic compound | 2.0 parts |
| Stearyl trimethyl ammonium salt | |
| (Trade name: Electro Stripper QE made by Kao Co., | |
| Ltd.) or | |
| Stearyl trimethyl ammonium chloride | 3.0 parts |
| (Trade name: You Tamin 86P made by Kao Co., Ltd.) | |
| High molecular component of a cationic compound | |
| Copolymer of diaryl amine salt acid and sulfur | |
| dioxide | |
| (average molecular weight; 5000) | |
| (Artilce name: polyamine sulfone PAS-92 made by | |
| Nitto Boseki Co., Ltd.) | |
| Thiodiglycol | ten parts |
| Water | the rest |

(2) Production of Color Ink (Dye Ink)

Ink of each color of yellow, magenta, cyan and black was produced by mixing the following components, and further pressurized and filtered through a membrane filter (Trade name: Fluoro pore filter made by Sumitomo Electric Industries Co., Ltd.) having a pore size of 0.22 μm to be adjusted.

### Yellow Ink

| | |
|---|---|
| C.I. direct yellow 142 | two parts |
| Thiodiglycole | ten parts |
| Trade name; Acetinol EH | 0.05 parts |
| (Kawa Ken Fine Chemical Co., Ltd.) | |
| Water | the rest |

### Magenta Ink

This ink has the same composition as the yellow ink other than a point of replacing the dye for C.I. acid red 289; 2.5 parts.

### Cyan Ink

This ink has the same composition as the yellow ink other than a point of replacing the dye for C.I. acid blue 9; 2.5 parts.

### Black Ink

This ink has the same composition as the yellow ink other than a point of replacing the dye for C.I. food black 2; 3 parts.

It should be noted that upon carrying out the present invention, the ink to be used is not limited particularly to the dye ink, pigment ink where pigment is dispersed may be used, and the treatment liquid to be used may adopt a liquid causing cohesion of the pigment.

As examples of the pigment ink causing the cohesion by mixing with the above treatment liquid, the following may be included.

(3) Production of Color Ink (Pigment Ink)

### Black Ink

An anionic polymer P-1 (stylene-methacrylic acid-ethylacrylate, an acid number 400, a weight-average molecular weight 6.000, solution of solid contents of 20%, and a neutralizing agent: potassium hydroxide) was used as a dispersant. This dispersant and the following materials were put into a batch type vertical sand mill (made by Imex Co., Ltd.), where glass beams each having a diameter of 1 mm were filled as media and the dispersing processing was executed for three hours in water-cooling. A viscosity after the dispersing was 9 cps and pH thereof was 10.0. Bulky particles in the dispersing liquid were removed by a centrifugal machine to produce a carbon black dispersant having a weight-average particle diameter of 100 nm.

| | |
|---|---|
| P-1 water solution (solid contents of 20%) | 40 parts |
| Carbon black | 24 parts |
| (Trade name: Mogul L, Cabrack Co., Ltd.) | |
| Glycerin | 15 parts |
| Ethylene glycol monobutyl ether | 0.5 parts |
| Isopropyl alcohol | 3 parts |
| Water | the rest |

Next, black ink K2 for inkjet containing pigment was obtained by sufficiently dispersing the above obtained dispersant. The solid contents of the final preparation were about 10%.

### Yellow Ink

An anionic polymer P-2 (stylene-acrylic acid-methylmethacrylate, an acid number 280, a weight-average molecular weight 11.000, solution of solid contents of 20%, and a neutralizing agent: diethanol amine) was used as a dispersant. This dispersant and the following materials were used to execute the dispersing processing in the same way with the production of black ink, producing a yellow color dispersing element having a weight-average particle diameter of 103 nm.

| | |
|---|---|
| P-2 water solution (solid contents of 20%) | 35 parts |
| C. I. pigment yellow 180 | 24 parts |

(Trade name: NOVAPERM YELLOW PH-G made by Hoechst Aktiengesellschaft)

| | |
|---|---|
| Triethylene grylcol | 10 parts |
| Diethylene glycol | 10 parts |
| Ethylene glycol monobutyl ether | 1.0 parts |
| Isopropyl alcohol | 0.5 parts |
| Water | the rest |

Yellow ink K2 for inkjet containing pigment was obtained by sufficiently dispersing the above obtained yellow dispersing element. The solid contents of the final preparation were about 10%.

### Cyan Ink

An anionic polymer P-1 used in producing the black ink was used as a dispersant. This dispersant and the following materials were used to execute the same dispersing processing as in a case of the carbon black dispersing element, producing a cyan color dispersing element having a weight-average particle diameter of 120 nm.

| P-1 water solution (solid contents of 20%) | 30 parts |
|---|---|
| C. I. pigment blue 15:3 | 24 parts |
| (Trade name: Fasutogen blue FGF made by Dainippon | |
| Ink & Chemicals) | |
| Glycerin | 15 parts |
| Diethylene glycol monobutyl ether | 0.5 parts |
| Isopropyl alcohol | 3 parts |
| Water | the rest |

Cyan ink for inkjet containing pigment was obtained by sufficiently stirring the above obtained cyan color dispersing element. The solid contents of the final preparation were about 9.6%.

### Magenta Ink

An anionic polymer P-1 used in producing the black ink was used as a dispersant. This dispersant and the following materials were used to execute the same dispersing processing as in a case of the carbon black dispersing element, producing a magenta color dispersing element having a weight-average particle diameter of 115 nm.

| | |
|---|---|
| P-1 water solution (solid contents of 20%) | 20 parts |
| C. I. pigment red 122 | 24 parts |
| (made by Dainippon Ink & Chemicals) | |
| Glycerin | 15 parts |
| Isopropyl alcohol | 3 parts |
| Water | the rest |

Magenta ink for inkjet containing pigment was obtained by sufficiently dispersing the above obtained magenta color dispersing element. The solid contents of the final preparation were about 9.2%.

According to the present invention, the treatment liquid and the color ink as mentioned above are mixed on the print medium or at a position where they are permeated into the print medium. As a result, the cationic component contained in the treatment liquid and the anionic component used in the color ink react with each other. Therefore, the color materials of the ink can be insoluble or cohesive to improve image performance such as image robustness or image quality.

### [Configuration of Printer]

Next, an configuration of an entire inkjet printer in the present embodiment will be explained. FIG. 1 is a perspective view showing a carriage and a portion in the vicinity thereof in the inkjet printer of the present embodiment. The inkjet printer in the present embodiment is provided with print heads 22 and liquid supplying tanks 21 for supplying ink and a treatment liquid to the print heads 22. The print head 22 is provided with a plurality of nozzles each having an ejection opening for ejecting liquid to an outside and a liquid passage communicating with the ejection opening and the respective ejection openings are arranged by predetermined pitches. The print heads 22 include print heads for ejecting the ink from ejection openings of the nozzles and print heads for ejecting the treatment liquid from ejection openings of the nozzles. These print heads each have the same arrangement. In addition, the ink and the treatment liquid are ejected from the ejection openings provided in the print head to the print medium 1, thus performing a print on the print medium 1. In the present embodiment, the printer includes five print heads 22K, 22Cy, 22M, 22Y and 22H for ejecting color ink of black (K), cyan (Cy), magenta (M) and yellow (Y) and a treatment liquid (H) respectively. Further, the ink tanks include five ink tanks 21K, 21C, 21M, 21Y and 21H for reserving the ink and the treatment liquid supplied respectively to the print heads 22K, 22Cy, 22M, 22Y and 22H. These print heads and ink tanks 21 are movable in a main scan direction (arrow X direction).

In addition, the inkjet printer in the present embodiment is provided with caps 20 each covering the ejection opening face of the print head. Here, the caps 20 include five caps 20K, 20C, 20M, 20Y and 20H for covering the respective ink ejection faces of the five print heads. The print head 22 and the ink tank 21 return back to a home position where the cap 20 is present and stand by therein.

It should be noted that in a case of referring to these print heads, ink tanks and caps individually, a reference number attached to each of them is used and in a case of referring to them collectively, as a collective reference number, numeral 22 is used to the print head, numeral 21 is used to the ink tank, and numeral 20 is used to the cap.

In the present example, the print head and the ink tank constitute a head cartridge such that they are integrally or separately formed, and the head cartridge is detachably mounted in a carriage (not shown). The print head and the ink tank may be separately mounted in the carriage without constituting the head cartridge. The carriage is guided along a main scan direction of an arrow X to be movable and is moved reciprocally in a main scan direction through the belt 4 by the carriage motor 2. The print medium 1 is conveyed in a sub scan direction (arrow Y direction) crossing (in a case of the present example, orthogonal) to the main scan direction by the carriage roller.

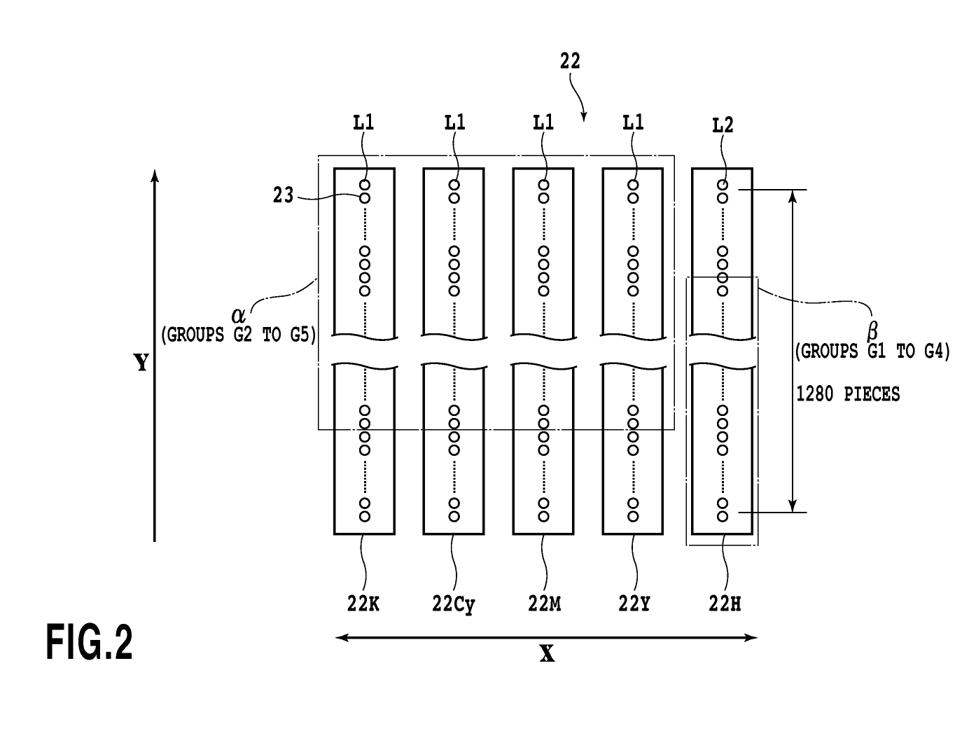

FIG. 2 is a view showing the print head 22 as viewed from the ejection opening side. The print head 22 is provided with 1280 pieces of ejection openings 22a arranged with density of 1200 dpi in a direction Y crossing to a main scan direction X (direction perpendicular to the main scan direction X in the figure), and an ejection amount of ink ejected one time from each ejection opening 22a is about 4 ng.

A print operation in the printer arranged as above will be explained with reference to the FIGS. 1 and 2. A plurality of plain papers stacked on a cassette (not shown) are supplied to a print operation area one by one by a feeding roller (not shown). In the print operation area, a plain paper 1 is conveyed between the print head 22 and a platen (not shown) by a carriage roller 3.

On one hand, the color ink and the treatment liquid are supplied to the print head 22 from the ink tank 21. The print head 22 performs a print on the plain paper as a print medium corresponding to binary image data while moving in an arrow X1 direction (forward scan direction) and X2 direction (backward scan direction) in FIG. 1. This print is performed by applying ink droplets of black, cyan, magenta, yellow and the treatment liquid in that order on the plain paper.

### [Configuration of Image Processing System]

FIG. 3 is a block diagram showing a schematic configuration of an inkjet printer which is a representative embodiment of the present invention.

A host computer (image input unit) 28 inputs multi-valued image data stored in various memory mediums such as a hard disc to an image processing unit 29 in an inkjet printer 301. The multi-valued image data can be received also from an image input device such as a scanner or a digital camera connected to the host computer 28. The image processing unit 29 executes image processing, which will be described later, to the multi-valued image data inputted from the image input unit 28 to be converted into binary image data. This data conversion generates the binary image data (color ink ejection data) for ejecting plural kinds of color ink from the print head. The binary image data (treatment liquid ejection data) for ejecting the treatment liquid also are herein generated. Therefore, the image processing unit 29 serves as ink ejection data generating unit and treatment liquid ejection generating unit. An image output unit 30 applies the color ink and the treatment liquid based upon the binary image data of the color ink and the treatment liquid converted in the image processing unit 29 to perform an image formation.

An image output unit 30 itself is controlled according to the program printed in a ROM 304 by a MPU (Micro Processor Unit) 302. A RAM 305 is used as an operation area of the MPU 302 or a temporal data storage area. The MPU 302 performs through an ASIC 303 control of a drive system 308 of the carriage, a conveyance drive system 309 of the print medium, a recovery drive system 310 of the print head and a drive system 311 of the print head. In addition, the MPU 302 is configured to be readable to a print buffer readable from the ASIC 303.

The print buffer 306 temporarily stores image data converted into a format transferable to the print head. A mask buffer 307 temporarily stores a predetermined pattern for executing AND processing to the data transferred from the print buffer 306 to the print head as needed. It should be noted that plural sets of mask patterns for a multi-path print of different path numbers are prepared in the ROM 304 and at an actual print, the corresponding pattern is read out from the ROM 304 and is stored in the mask buffer 307.

### [Print Operation]

Next, a print operation in the present embodiment will be explained. The present embodiment adopts a multi-pass printing system in which plural times of reciprocal scans are performed in a predetermined area to apply ink and treatment liquids. Here, the print scan is performed by five times of the reciprocal scans. In addition, in the following explanation, for simple explanation, the kinds of ink used for printing an image are composed only of cyan (cy) ink and magenta (M) ink.

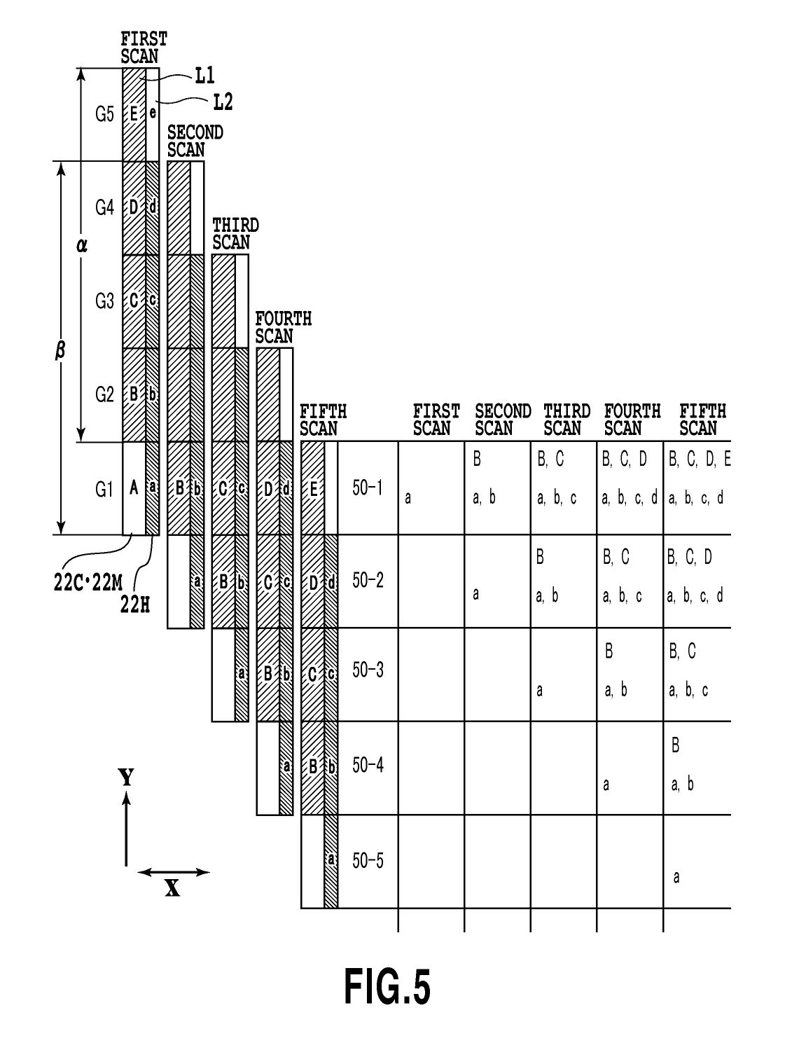

FIG. 5 is an explanatory view of a printing method in the present embodiment. Opening arrayopening arrayThe print heads 22Cy and 22M for cyan (Cy) and magenta (22M) ink and the print head 22H for treatment liquid respectively are provided with 1280 pieces of ejection openings. 1280 pieces of the ejection openings of each print head are divided equally into five groups G1, G2, G3, G4 and G5 (ejection opening group), each having 256 pieces of the ejection openings.

In the print heads 22Cy and 22M, 1024 pieces of the ejection openings within a range α (refer to FIG. 2) of the groups G2 to G5 are used for ejection of ink. In the following explanation, the ejection openings in the groups G2 to G5 respectively are also called ejection openings in areas B, C, D and E. In addition, in the print head 22H, 1024 pieces of the ejection openings within a range β (refer to FIG. 2) of the groups C1 to G4 are used. In the following explanation, the ejection openings in the groups G1 to G4 respectively are also called ejection openings in areas a, b, c and d. In FIG. 5, numerals 50-1, 50-2, 50-3, 50-4 and 50-5 show print areas on the print medium 1 corresponding to one group in the print head.

First, in a first scan, a treatment liquid is ejected from the ejection openings in the area of the print head 22H based upon ejection data of the treatment liquid at the first scan in the print area 50-1.

Next, the print medium 1 is conveyed in a sub scan direction (Y direction) by a length of ⅕ of the print head. It should be noted that in FIG. 5, the print head 22 is expressed to relatively move in a reverse direction to the sub scan direction.

Thereafter, in a second scan, ink is ejected from the ejection openings in the area B of the print heads 22Cy and 22M based upon ejection data of the ink at the second scan in the print area 50-1. In addition, the treatment liquid is ejected from the ejection openings in the area b of the print head 22H based upon ejection data of the treatment liquid at the second scan. At the second scan, a first scan to the print area 50-2 is performed at the same time and the treatment liquid is ejected from the ejection openings in the a area of the print head 22H.

Next, the print medium 1 is conveyed in the sub scan direction by a length of ⅕ of the print head. Thereafter, in a third scan, the ink is ejected from the ejection openings in the C area of the print heads 22Cy and 22M based upon ejection data of the ink liquid at the third scan in the print area 50-1. In addition, the treatment liquid is ejected from the ejection openings in the area c of the print head 22H based upon ejection data of the treatment liquid at the third scan. Further, at the third scan, a second scan to the print area 50-2 and a first scan to the print area 50-3 are performed to eject the ink from the ejection openings in the areas B, b and a of the print heads 22Cy, 22M and 22H.

Next, the print medium 1 is conveyed in the sub scan direction by a length of ⅕ of the print head. Thereafter, in a fourth scan, the ink is ejected from the ejection openings in the area D of the print heads 22Cy and 22M based upon ejection data of the ink at the fourth scan in the print area 50-1. In addition, the treatment liquid is ejected from the ejection openings in the area d of the print head 22H based upon ejection data of the treatment liquid at the fourth scan. Further, at the fourth scan, a third scan to the print area 50-2, a second scan to the print area 50-3 and a first scan to the print area 50-4 are performed. During the first scan, the ink and the treatment liquid are ejected from the ejection openings in each of the areas C, c, B, b and a of the print heads 22Cy, 22M and 22H. The application of the treatment liquid to the print area 50-1 is completed by the first scan to the fourth scan.

Next, the print medium 1 is conveyed in the sub scan direction by a length of ⅕ of the print head. Thereafter, in a fifth scan, the ink is ejected from the ejection openings in the area E of the print heads 22C and 22M based upon ejection data of the ink at the fifth scan in the print area 50-1. At the fifth scan, a fourth scan to the print area 50-2, a third scan to the print area 50-3, a second scan to the print area 50-4 and a first scan to the print area 50-5 are performed. During this period, the ink and the treatment liquid are ejected from the ejection openings in each of the areas D, d, C, c, B, b and a of the print heads 22Cy, 22M and 22H.

The print of the image by the ink to the print area 50-1 is completed by the second scan to the fifth scan.

Hereinafter, by repeating the similar scan, the print of the image and the application of the treatment liquid on the print areas 50-2, 50-3, 50-4 and 50-5 are sequentially completed. The application of the treatment liquid is performed based upon the ejection data generated by the characteristic processing which will be explained below.

### [Method of Generating Ejection Data of Treatment Liquid]

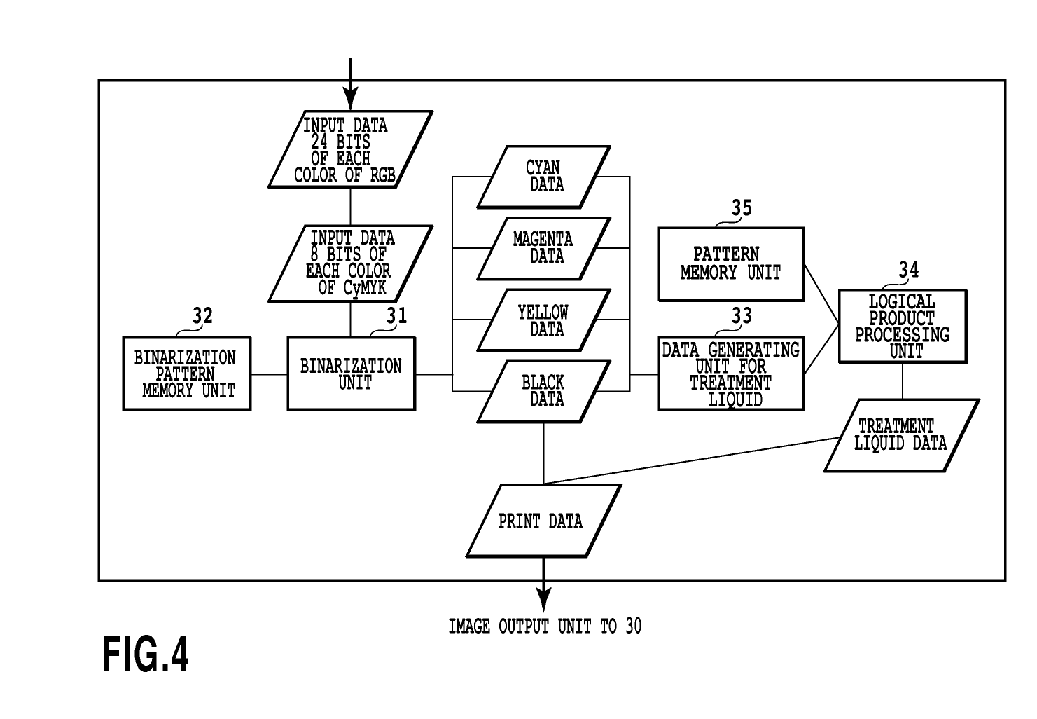

Next, the aforementioned characteristic processing in the present embodiment will be explained with reference to FIGS. 4 and 6 to 14. It should be noted that “characteristic processing” herein unit processing of generating ejection data of the treatment liquid based upon ejection data of the color ink to eject the treatment liquid by a scan immediately before the color ink is ejected.

FIG. 4 is a block diagram of the image processing unit 29 in FIG. 3. In the present embodiment, multi-valued image data of RGB format are inputted from the image input unit 28. Next, the multi-valued image data of the RGB format are converted into a multi-valued image data (image data of eight bits) corresponding to each of plural kinds of ink (K, Cy, M and Y) used for image formation. Further, the image data of eight bits corresponding to each kind of the ink is converted into a binary image data corresponding to each kind of the ink according to a pattern stored in binarization pattern memory unit 32 in binarization unit 31 and this binary image data is developed into a bit map data. As described above, the binary image data (ink ejection data) for applying each of the plural kinds of the color ink is generated. In addition, the generated binary image data (ink ejection data) is divided into plural times of the scans of the print head using a well-known pattern. The image processing to be described later is executed based upon the binary image data of the plural kinds of the ink (ink ejection data) thus generated, to generate treatment liquid ejection data for applying the treatment liquid. For the generation of the treatment liquid ejection data, treatment liquid data generating unit 33, pattern memory unit 35 of the treatment liquid and logical multiplication processing unit (AND circuit) 34 are used.

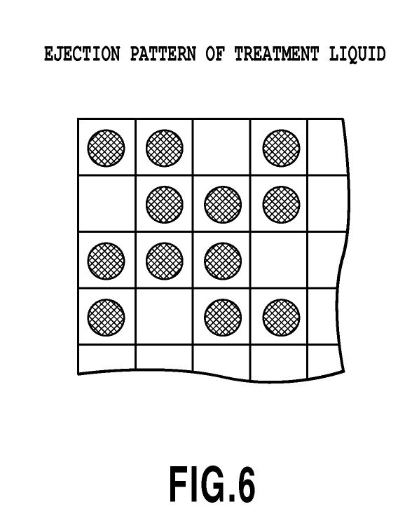

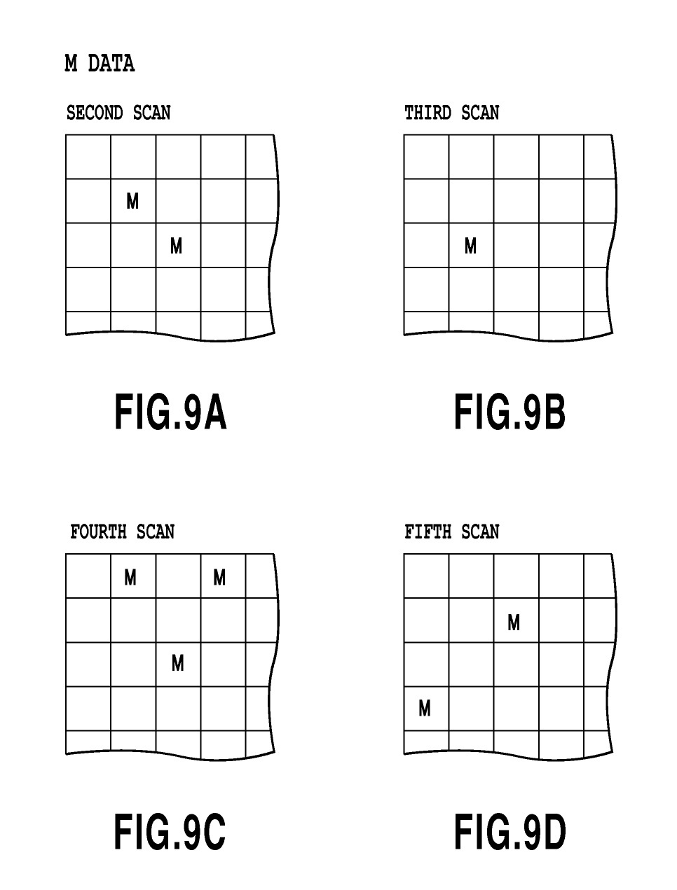

FIG. 6 is a view showing a pattern of the treatment liquid stored in the pattern memory unit 35 (refer to FIG. 9). The ejection pattern of the treatment liquid is a pattern in which a print duty of the treatment liquid is 75% in a unit matrix composed of 4×4 pixels (16 pixels). The print duty of the treatment liquid is a value expressing a ratio of the number of pixels (dot number) in the unit matrix on which the treatment liquid is applied, to the number of all pixels (16 pixels) in the unit matrix. Likewise the print duty of the ink is a value expressing a percentage of ratio percentage of the number of pixels (dot number) in the unit matrix on which the ink is applied, to the number of all pixels (16 pixels) in the unit matrix. Here, the ejection pattern shown in FIG. 6 is a pattern in which the dot number of the treatment liquid can be controlled to 75% of the ink dot number constituting a color ink solid portion, to the color ink solid portion in which the print duty of the ink becomes 100%. The treatment liquid pattern is in advance set in the print duty of the treatment liquid necessary for improving coloring of the color ink on the print medium or the like. However, the ejection pattern of the treatment liquid may be a pattern as having the same print duty as the print duty of the color ink.

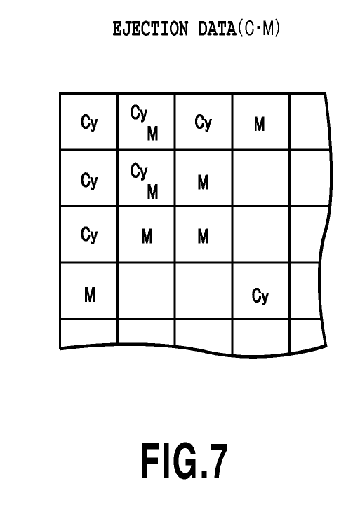

There will be, as described above, explained the ejection data of the treatment liquid generated based upon the binary bit map data (Cy and M data) in the cyan ink and magenta ink developed by the binarization unit 31 in FIG. 4. In a case where the Cy and M data, as shown in FIG. 7, form ink dots of cyan and magenta in the print area 50-1 (refer to FIG. 5), the ejection data of the treatment liquid are generated by the following image processing. In FIG. 7 and the following figures, the Cy data for forming the dot of the cyan ink is denoted at “C” and the M data for forming the dot of the magenta ink is denoted at “M”.

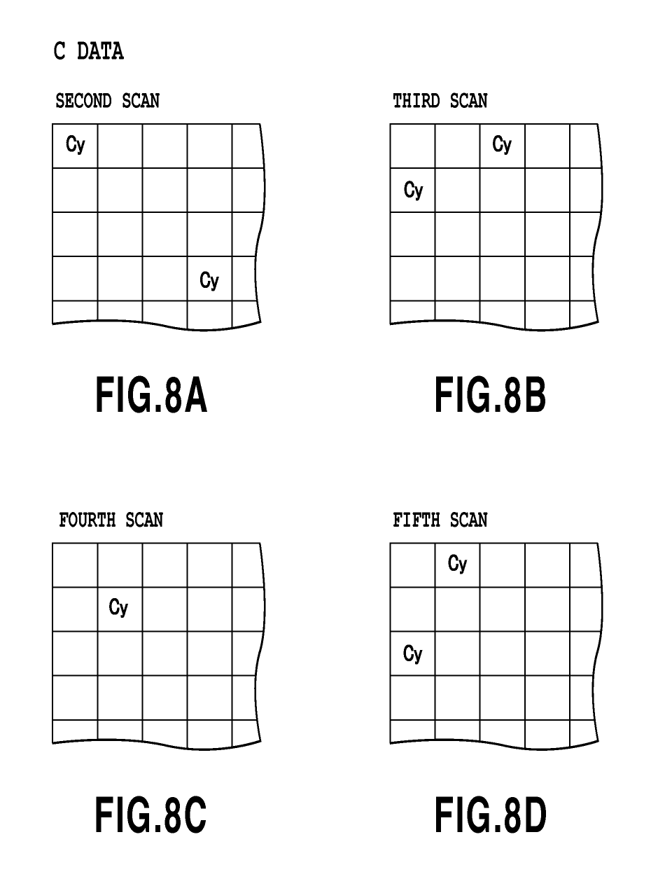

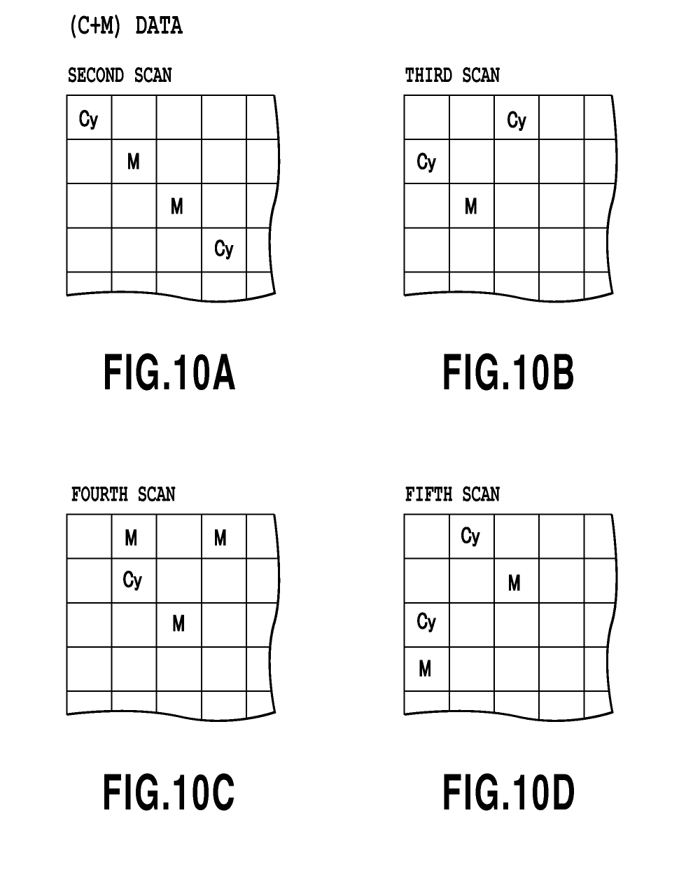

First, the data generating unit 33 (refer to FIG. 4) for treatment liquid detects in one pixel unit from what scan number the image formation by cyan ink and magenta ink is started, based upon binary bit maps (Cy and M data) for the cyan ink and the magenta ink. Therefore, the Cy data and the M data for the cyan ink and the magenta ink are separated into data for each of a second scan to a fifth scan. The Cy data and the M data in the second, third, fourth and fifth scans in the print area 50-1 correspond to the areas B, C, D and E of the print heads 22Cy and 22M. In the present embodiment, the Cy data are separated as shown in FIG. 8A to FIG. 80 and the M data are separated as shown in FIG. 9A to FIG. 9D. In addition, as shown in FIG. 10A to FIG. 10D, an addition of the Cy data and the M data is found for each scan.

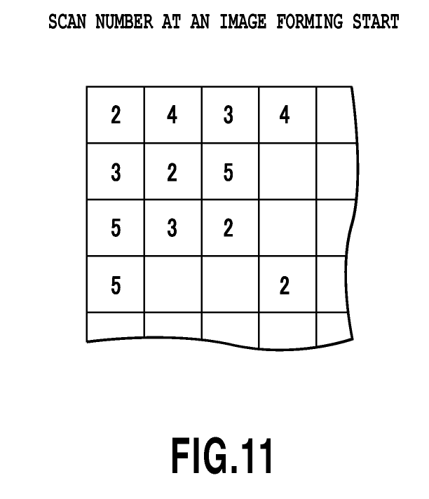

In FIG. 11, the data (FIG. 10A) of the second scan are expressed to be replaced by numeral “2”, the data (FIG. 10B) of the third scan are expressed to be replaced by numeral “3”, the data (FIG. 10C) of the fourth scan are expressed to be replaced by numeral “4”, the data (FIG. 10D) of the fifth scan are expressed to be replaced by numeral “5”. In a case where data of different scans overlap in the same pixel, a smaller numeral is adopted. This is done for determining the scan where the image formation (application of the ink) by the color ink is started to each pixel, that is, the scan when the ink is first applied on the pixel.

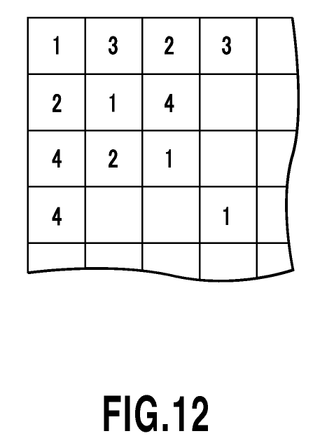

In this way, it is determined in one pixel unit (each unit area) what scan number the scan starting the image formation (hereinafter, print start scan) corresponds to. That is, the scan number (from 2 to 5) at an image forming start is determined based upon the data in FIGS. 10A to 10D. As described later, for ejecting the treatment liquid at a scan before the print start scan (here, immediately before the print start scan), numeral “1” is subtracted from each of the numerical values in FIG. 11 to set scan numbers shown in FIG. 12. The scan number shown in FIG. 12 is a scan number for applying the treatment liquid to each pixel.

The above processing is the processing content in the data generating unit 33 for treatment liquid.

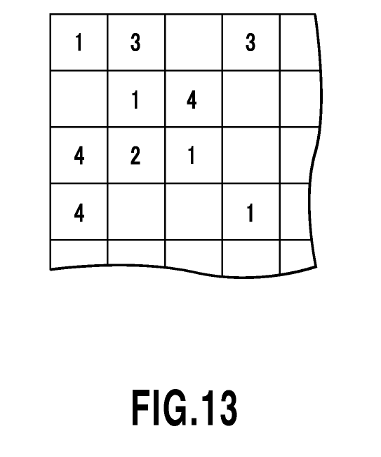

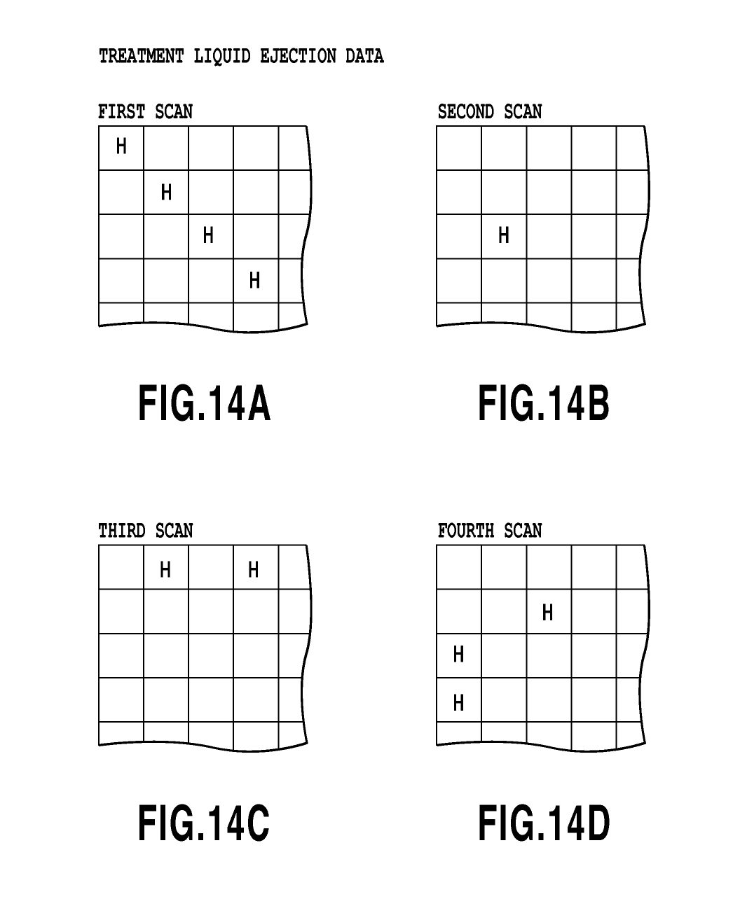

Next, AND of the pattern in FIG. 6 in advance stored in the memory unit 35 and the data in FIG. 12 generated by the generating unit 33 is found by the logical multiplication processing unit 34 to generate data thinned as shown in FIG. 13. The data are distributed from the first scan to the fourth scan of the print head 22H for treatment liquid according to the scan numbers set in FIG. 12. That is, the data by AND with the ejection pattern shown in FIG. 6 are, as shown in FIGS. 14A to 14D, distributed to the first, second, third and fourth scans corresponding to numerals “1”, “2”, “3” and “4”. In FIGS. 14A to 14D, the data for treatment liquid (dot data) is expressed by “H”. The treatment liquid ejection data thus generated are transmitted as print data to the image output unit 30 together with the bit map data of color ink in each color. As described above, in the first, second, third, and fourth scans, the ejection openings within the β range (areas a, b, c and d) of the print head 22H are used to eject the treatment liquid.

By thus generating the ejection data of the treatment liquid for each scan, as described later, it is possible to eject the treatment liquid by a scan immediately before the color ink is ejected. In addition, in the print head 22H for treatment liquid, it can be prevented that the ejection openings to be used become primarily those in a particular range. It should be noted that a method of generating the ejection data of the treatment liquid from the ejection data of each ink color and a method of distributing the ejection data of the treatment liquid to each scan are not limited to the aforementioned method.

In the present embodiment, as described above, in the plural times of the scans for forming the image, it is detected for each one pixel what scan number the scan at which the ink is first applied corresponds to. That is, the order of the scan for starting the image formation (print start scan) is detected for each one pixel, and the treatment liquid is ejected at a scan before the detected scan. In consequence, the liquid first ejected to each pixel is the treatment liquid and in a position where the treatment liquid is permeated on or into the print medium, the treatment liquid is mixed and reacts with the color ink ejected at a scan immediately after the scan at which the treatment liquid is applied. As a result, the color material of the ink can be insoluble or cohesive to improve image performance such as image robustness and image quality. In addition, since the treatment liquid is always applied at the scan immediately before the ink is applied, the time interval from a point where the treatment liquid is applied to a point where the ink is applied can be substantially uniformed. Therefore, the ink can appropriately react with the treatment liquid simply by applying the treatment liquid in a location only where the ink is applied, without application of a large number of treatment liquids to obtain a uniform image performance improvement effect in an entire image to be printed. That is, in an image to be printed, generation of the color unevenness, the bleeding, the beading, the drying defect and the like can be reduced.

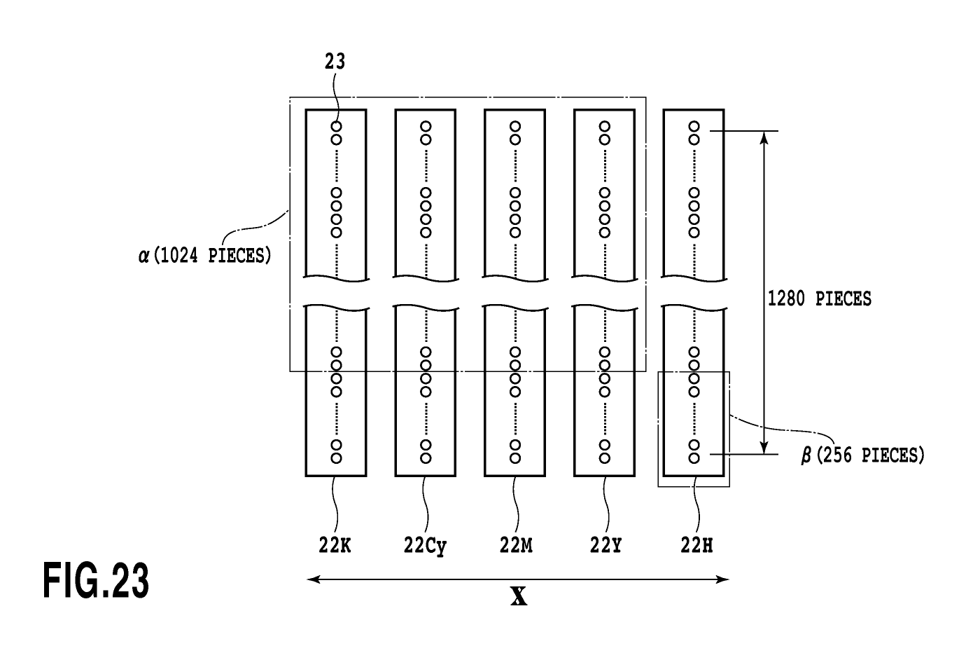

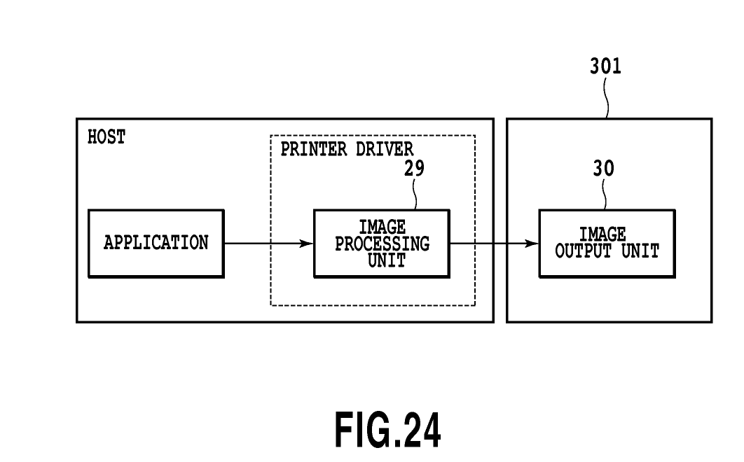

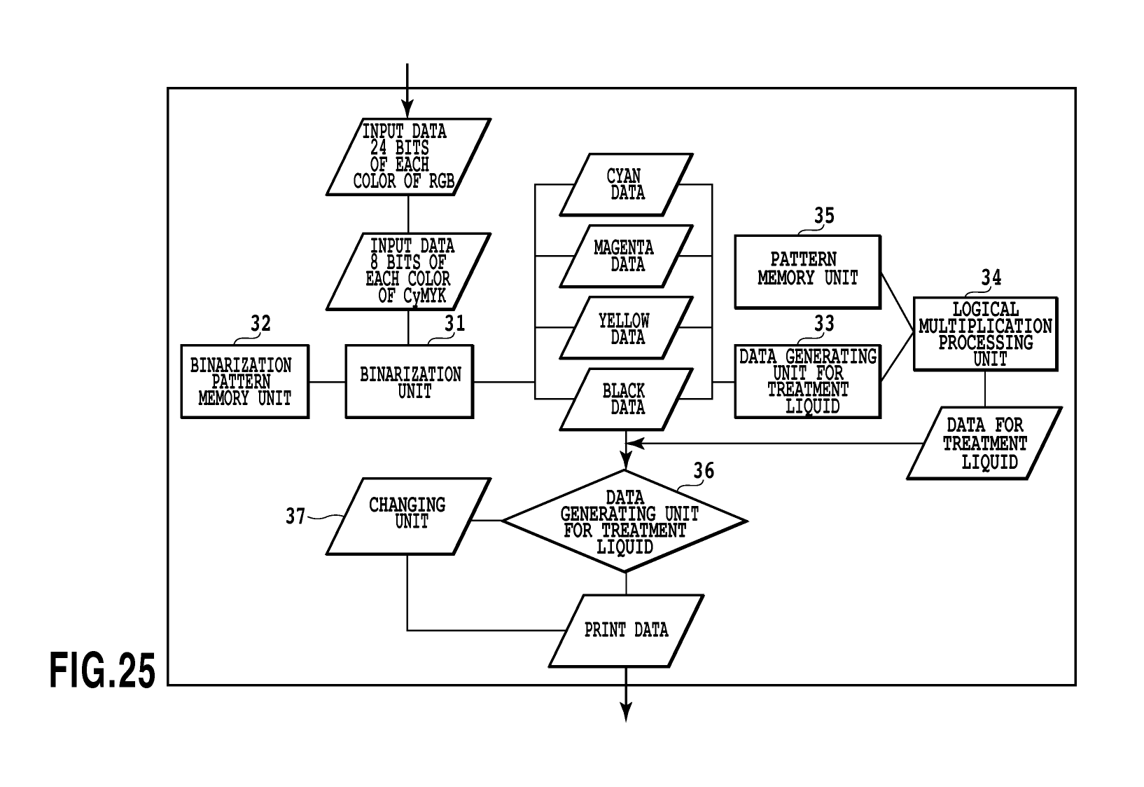

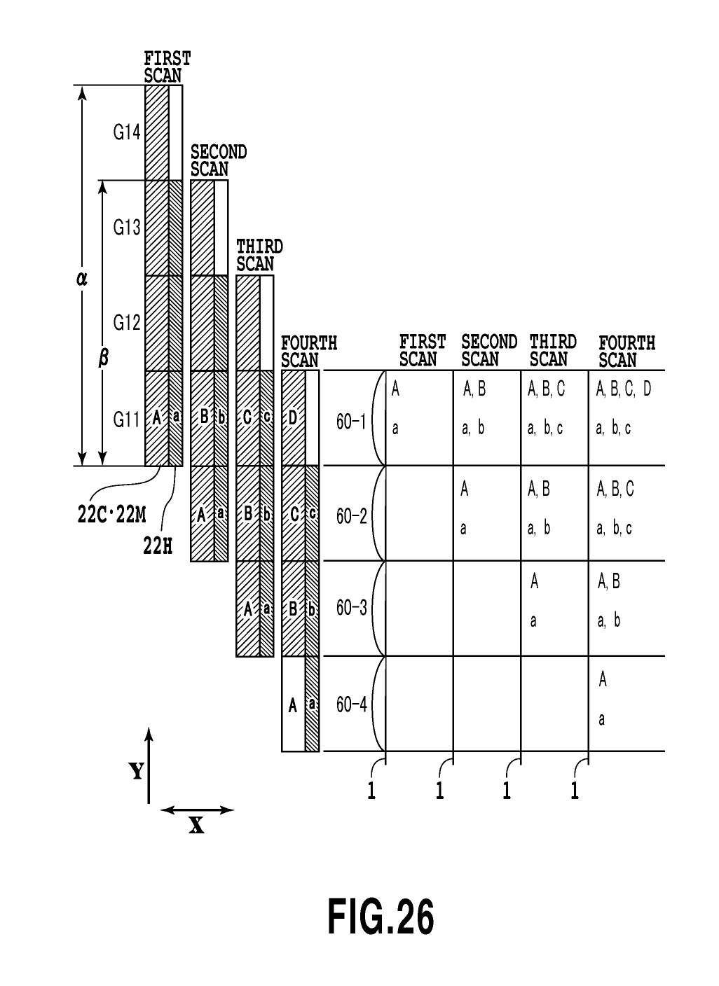

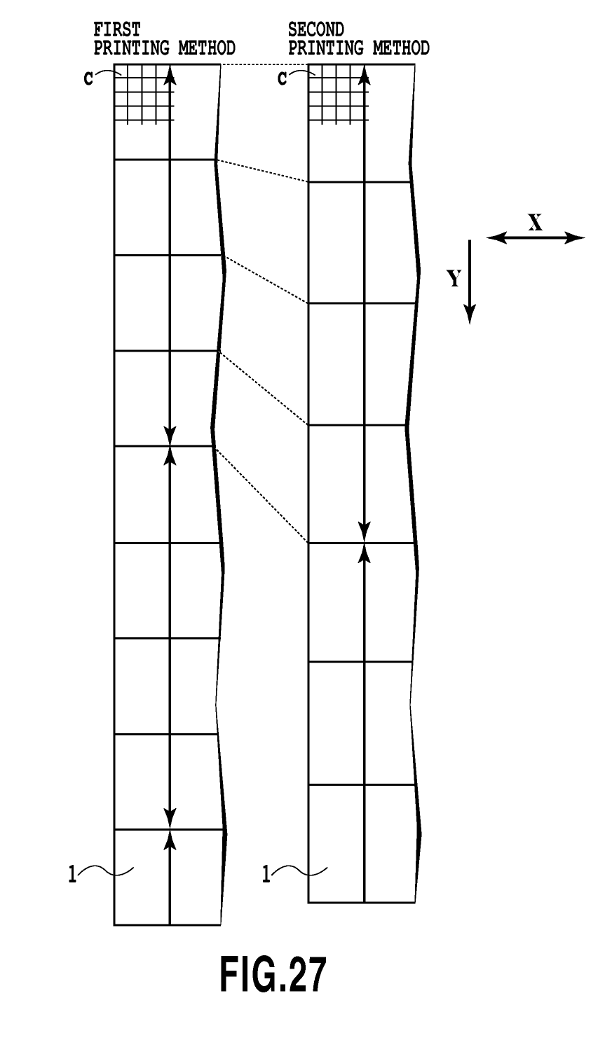

In addition, since it is possible to prevent the ejection openings used in the print head 21H from becoming primarily those in a particular range by dispersing the ejection of the treatment liquid to the plural times of the scans, durability of the nozzle can be improved. On the other hand, in the conventional multi-pass print, the ejection timing of the treat liquid is determined as an initial scan time (first scan time) only. In this case, for example, in FIG. 23, the nozzles within the β range are intensively used. In consequence, the durability of the nozzle is damaged and the other nozzles become wasteful since they are not used at all. The present embodiment can solve this conventional problem.

### 2. Second Embodiment

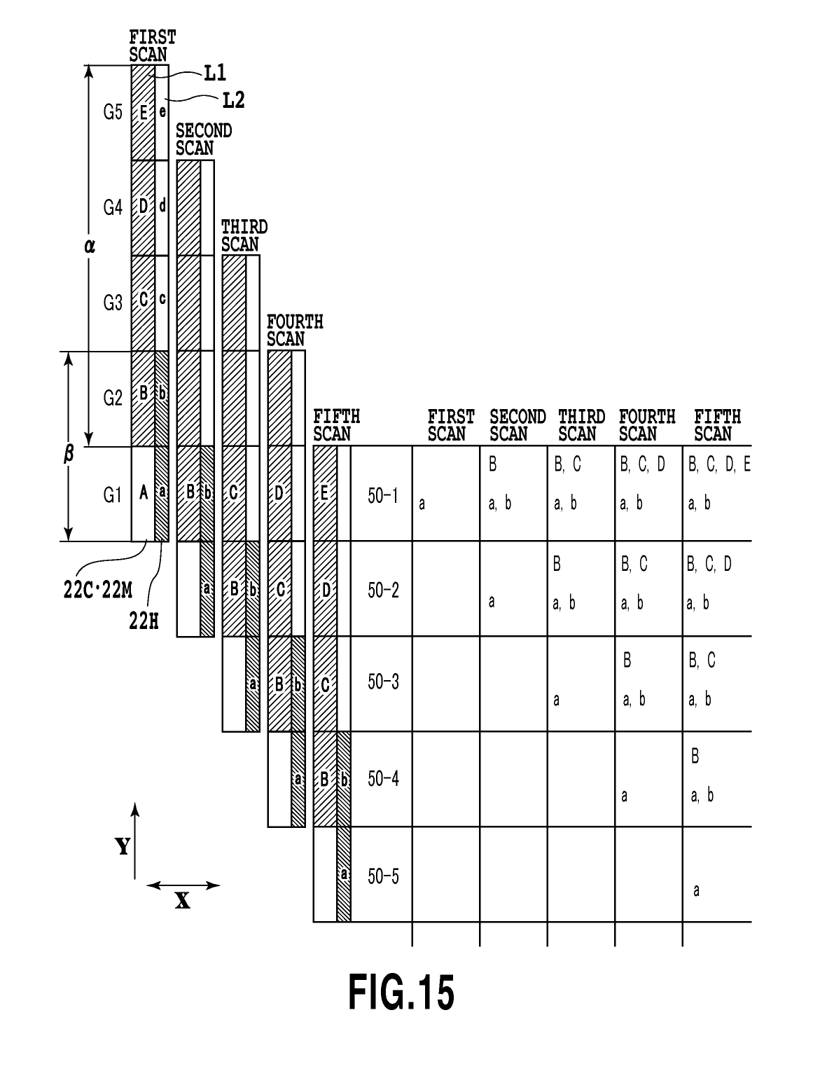

Next, a second embodiment in the present invention will be explained with reference to FIGS. 15 to 22. It should be noted that the second embodiment also, in the same way with the first embodiment, has the arrangement shown in FIGS. 1 to 4, and components in the second embodiment identical to those in the first embodiment are referred to as identical codes, and the detailed explanation is omitted.

The second embodiment also, in the same way with the first embodiment, adopts a multi-pass printing system in which the nozzle line of the print head is equally divided into five ejection opening groups and five times of scans are performed to each scan area using the different ejection opening groups to complete an image formation. The second embodiment uses a mask pattern for dividing the ejection data of each color ink into plural times of scans to in advance prepare a mask pattern in such a manner that application of the treatment liquid is made before ejection of the ink, and the treatment liquid is ejected only in twice scans of the initial scan and the next scan. The second embodiment differs in this respect from the first embodiment.

Hereinafter, a printing method in the second embodiment will be explained, but ink used for formation of an image is explained as cyan (Cy) and magenta (M) only in the same way with the first embodiment.

FIG. 15 is an explanatory view of the printing method in the present embodiment, and in the same way with the aforementioned first embodiment, the print of an image in the print area 50-1 by Cy and M ink is completed by the second scan to the fifth scan. On the other hand, the application of the treatment liquid is performed in twice scans composed of the first scan as the initial scan and the next second scan. The ejection data for thus ejecting the treatment liquid are generated as follows.

As described before, the image data of Cy and M ink (Cy data and M data) are binarized by the binarization unit 31 in FIG. 4 and developed to bit maps. In a case where the Cy data and the M data are used to form Cy and M ink dots in the print area 50-1 (refer to FIG. 15), the ejection data of the treatment liquid are generated by the following image processing.

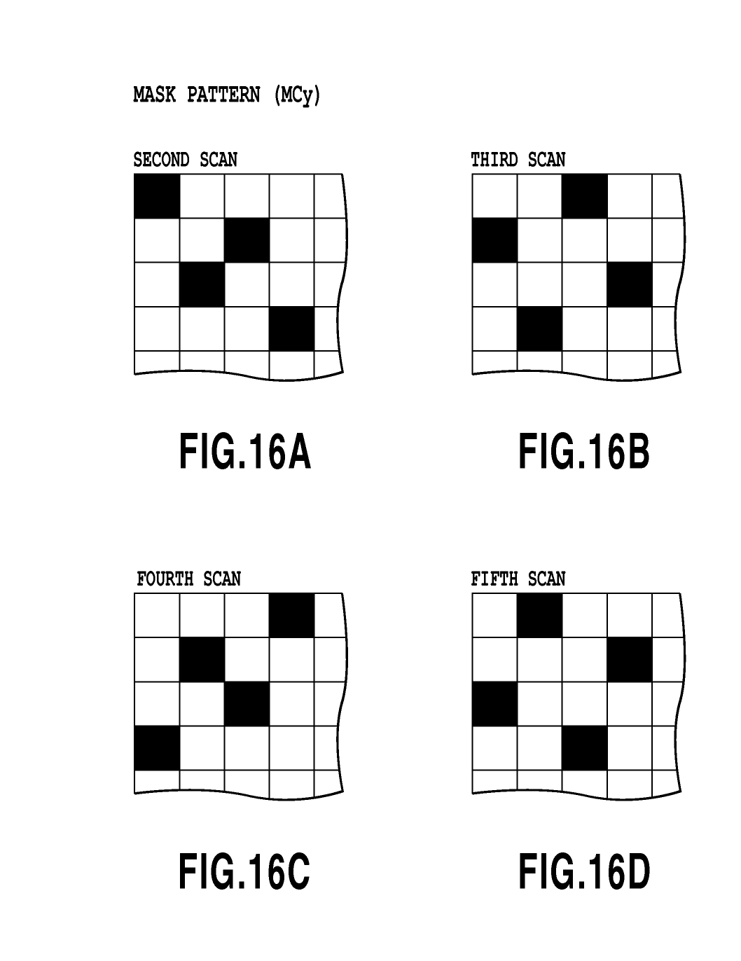

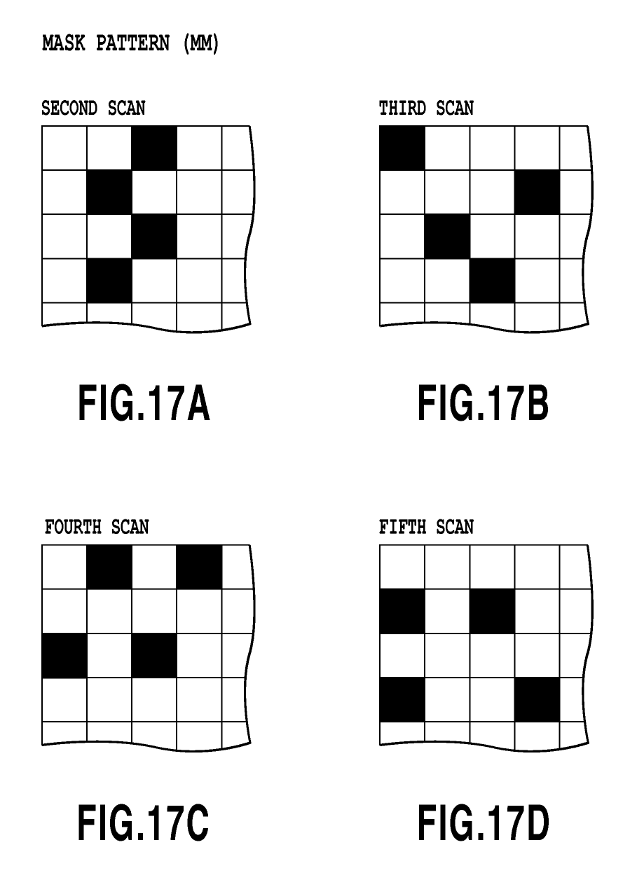

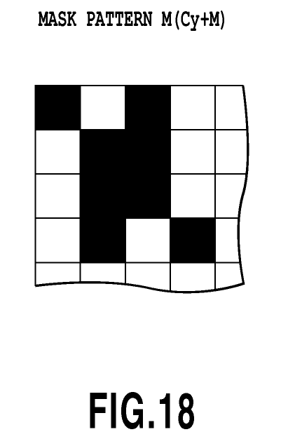

First, the Cy data and the M data are separated into data for each of a second scan to a fifth scan. For example, the Cy data and the M data in the second, third, fourth and fifth scans performed in the print area 50-1 correspond to the areas B, C, D and E of the print heads 22Cy and 22M. In the same way with the aforementioned first embodiment, the Cy data are separated as shown from FIG. 8A to FIG. 8D and the M data are separated as shown from FIG. 9A to FIG. 9D. The Cy data are separated by using mask patterns (first mask pattern) MCy of random mask patterns in FIGS. 16A to 16D in advance prepared. The M data are separated by using mask patterns (first mask pattern) MCy of random mask patterns in FIGS. 17A to 17D in advance prepared. FIG. 18 shows a mask pattern M (Cy+M) corresponding to an addition of the mask MCy of the second scan and the mask MM of the second scan. It should be noted that in FIGS. 16A to 16D and FIGS. 17A to 17D, the pixel marked out in black shows a pixel in which a pixel dot can be formed.

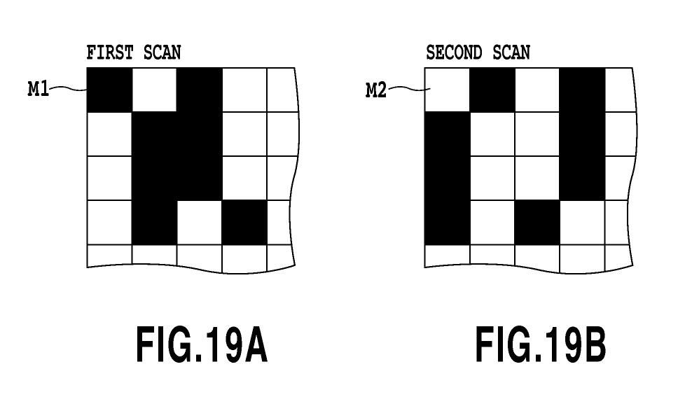

A mask pattern M1 (second mask pattern) in FIG. 19A is used for generating ejection data of the treatment liquid at the first scan. The mask pattern M1 is the same pattern as the mask pattern M (Cy and M) in FIG. 18. A mask pattern M2 (second mask pattern) complementary to a mask pattern shown in FIG. 19A is, as shown in FIG. 19B, used for generating ejection data of the treatment liquid at the second scan.

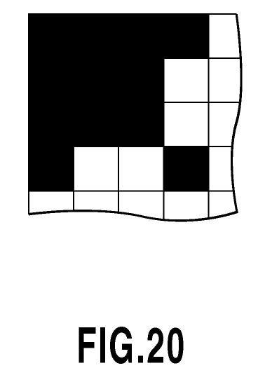

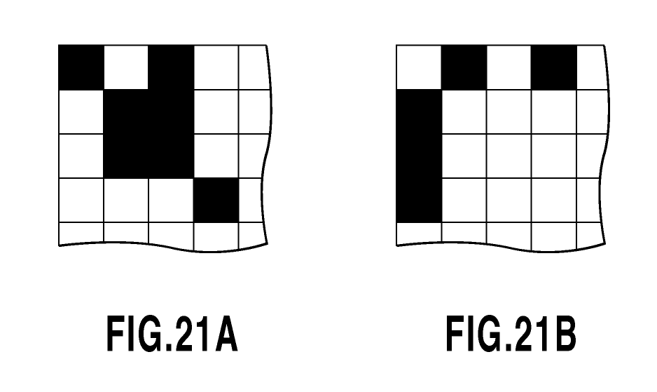

Now, as shown in FIG. 7, there will be reviewed a case where data showing pixels forming ink dots of Cy and M in the print area 50-1 (refer to FIG. 15) are data shown in FIG. 20. In this case, data shown in FIGS. 21A and 21B are generated with AND of the data for treatment liquid corresponding to FIG. 20 and the mask pattern of each in FIGS. 19A and 19B. That is, the data shown in FIG. 21A are generated with AND of the pattern shown in FIG. 20 and the mask pattern shown in FIG. 19A. In addition, the data shown in FIG. 21B are generated with AND of the pattern shown in FIG. 20 and the mask pattern shown in FIG. 19B. The above processing is a content of the processing in the data generating unit 33 for treatment liquid.

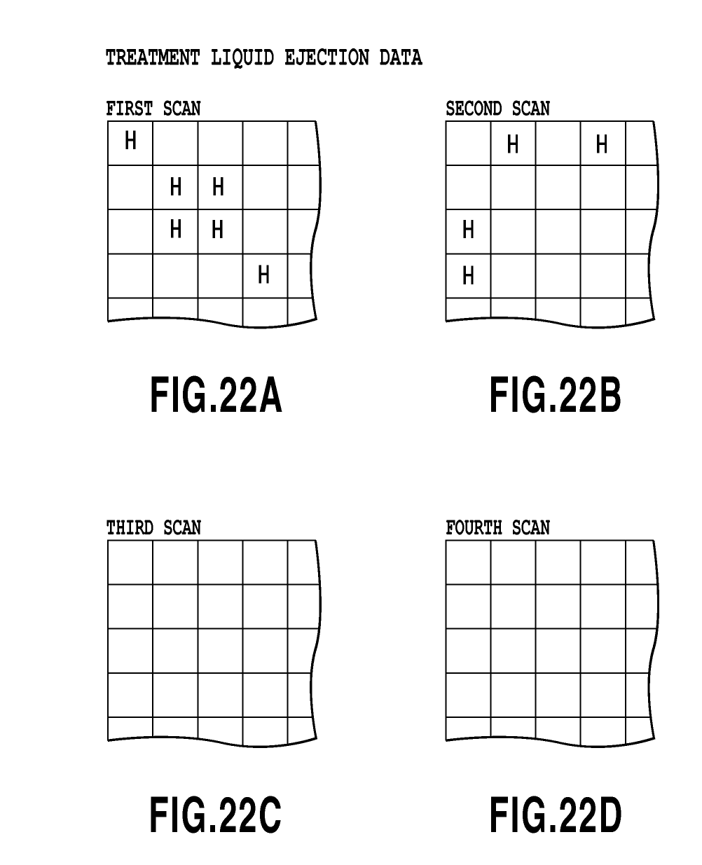

Next, ejection data of the treatment liquid shown in FIGS. 22A to 22D are generated with AND of the pattern in FIG. 6 in advance stored in the memory unit 35 and the data for treatment liquid generated by the generating unit 33. That is, ejection data of the treatment liquid at the first scan, as shown in FIG. 22A, are generated with AND of the ejection pattern of the treatment liquid shown in FIG. 6 and the data shown in FIG. 21A. In addition, ejection data of the treatment liquid at the second scan, as shown in FIG. 22B, are generated with AND of the ejection pattern of the treatment liquid shown in FIG. 6 and the data shown in FIG. 21B.

As shown in FIG. 15, the ejection openings in the area a of the print head 22H are used for ejection of the treatment liquid at the first scan and the ejection openings are used in the area b at the second scan. That is, the ejection openings in the areas a and b can be used to eject the treatment liquid at twice scans separately.

It should be noted that a method of generating the ejection data of the treatment liquid from the mask pattern for generating the ejection data of each ink is not limited to the aforementioned method only.

In this way, in the second embodiment, the mask patterns for treatment liquid for ejecting the treatment liquid are in advance prepared at two separate scans composed of the initial scan and the next scan based upon the mask pattern used for the image formation by the color ink. Therefore, the ejection pattern of the treatment liquid at each scan, that is, an arrangement pattern of dots formed by the treatment liquid can be in advance determined. As a result, the control for printing can be simplified to short the time required for the control.

Further, the second embodiment is configured such that the treatment liquid is applied at the scan (first scan) immediately before the second scan where ink is ejected and at the second scan corresponding to the application of ink by the third, fourth and fifth scans where the ink is ejected. In consequence, in regard to the ink ejected at each scan after the second scan, a difference in the time interval from a point where the treatment liquid is applied to a point where the ink is applied is generated. However, as compared to a case where the treatment liquid is applied by the one initial scan only as conventional, the present embodiment where the treatment liquid is applied at the initial scan and the second scan separately can reduce the difference in the time interval from a point where the treatment liquid is applied to a point where the ink is applied is generated. Therefore, the effect by the treatment liquid can be largely increased as compared to the conventional technology, thus obtaining an image with high quality.

### 3. Third Embodiment

Next, a third embodiment of the present invention will be explained with reference to FIG. 25 to FIG. 27. It should be noted that the third embodiment also has the configuration shown in each of FIG. 1 to FIG. 3 in the same way as the first embodiment, and components identical to those in the first embodiment are referred to as identical codes and its detailed explanation is omitted. The third embodiment is also provided with 1280 pieces of the ejection openings in the print head equally divided into five ejection opening groups similarly to the first embodiment, and adopts a multi-path printing method (first print operation) completing an image by performing five times of scans on each scan area using the different ejection groups. However, in a case where the ejection data for ejecting the treatment liquid does not exist at the first scan at which the treatment liquid only is ejected or in a case where the ejection data is less than a predetermined value, the first print operation is changed to the second print operation. That is, the multi-path printing system is changed to the print method in which the ejection data of the treatment liquid at the first scan is eliminated, the print width corresponding to one scan is changed and four times of scans are performed to complete an image. This point of the third embodiment is different from that of the first embodiment. Hereinafter, the printing method of the third embodiment will be explained, but plural kinds of the ink used for image formation will be explained only as cyan (Cy) and magenta (M) similarly to the first embodiment.

### [Method of Generating Ejection Data of Treatment Liquid]

FIG. 25 is a block diagram of the image processing unit 29 in the present embodiment. As described above, the image data of the Cy and M ink are binarized by the binarization unit 31 and developed to the bit map. In addition, the image processing described above is executed based upon the Cy data and the M data to generate ejection data of the treatment liquid. Next, final scan determining unit 36 determines a data amount at the first scan where only the treatment liquid is ejected, among the ejection data of the treatment liquid. In the present example, the data amount of the ejection data of the treatment liquid at the first scan is compared with a predetermined threshold value for each predetermined unit print area. In a case where the data amount is more than the predetermined threshold value, the ejection data of color ink in each color and the ejection data of the treatment liquid are sent as print data to the image output unit 30 as they are. In addition, as described above, at the first, second, third and fourth scans, the ejection openings in the β range (a, b, c and d areas) of the print head 22H are used to eject the treatment liquid. At the second, third, fourth and fifth scans, the ejection openings in the α range (a, b, c and d areas) of the print heads 22C and 22M are used to eject the treatment liquid.

On the other hand, in a case where the data amount at the first scan where only the treatment liquid is ejected is smaller than the predetermined threshold value, the ejection data of the color ink in each color and the ejection data of the treatment liquid are sent to changing unit 37. For example, in a case where the ejection data of the treatment liquid does not exist over an entire area of one page of the print medium at the first scan, the ejection data of the color ink in each color and the ejection data of the treatment liquid are sent to the changing unit 37. This is a case where there does not exist the data for ejecting the treatment liquid from the ejection openings in the a area over an entire area of one page of the print medium. Alternatively, in a case where the data amount of the ejection data is less than the threshold value, the ejection data of the treatment liquid at the first scan may be added to the ejection data of the treatment liquid at the next scan.

The changing unit 37 changes the above-mentioned print operation to the second print operation to be described later. The second print operation is a printing method of forming an image by four times of scans alone. In the second print operation, the first scan in the above-mentioned print operation, that is, the scan of ejecting the treatment liquid only does not exist. Therefore, the ejection data of the treatment liquid at the first scan is not necessary and therefore is eliminated. In this way, the changing unit 37 eliminates the ejection data of the treatment liquid at the first scan and generates the ejection data of the color ink in each color and the treatment liquid for performing the second print operation (performing image formation by four times of scans).

### [Second Print Operation]

FIG. 26 is an explanatory view of the second printing method. The print heads 22Cy and 22M for ejecting Cy (cyan) and M (magenta) ink and the print head 22H for ejecting a treatment liquid respectively are provided with 1280 pieces of ejection openings. 1280 pieces of the ejection openings of each print head are divided equally into four groups G11, G12, G13 and G14 (ejection opening group), each group having 320 pieces of the ejection openings. In the print heads 22Cy and 22M, 1280 pieces of the ejection openings within a range α (refer to FIG. 26) of the groups G11 to G14 are used for ejection of ink. In the following explanation, the ejection openings in the groups B11 to B14 respectively are also called ejection openings in A, B, C and D areas. In addition, in the print head 22H, 960 pieces of the ejection openings within a range β of the groups G11 to G13 are used. In the following explanation, the ejection openings in the groups B11 to B13 respectively are also called ejection openings in a, b and c areas.

First, in a first scan, based upon ejection data at the first scan to the print area 60-1, ink is ejected from the ejection openings in the A area of the print heads 22C and 22M and a treatment liquid is ejected from the ejection openings in the a area of the print head 22H. Next, the print medium 1 is conveyed in a sub scan direction (arrow Y direction) by a length of ¼ of the print head. Thereafter, in a second scan, based upon ejection data at the second scan to the print area 60-1, ink is ejected from the ejection openings in the B area of the print heads 22C and 22M and a treatment liquid is ejected from the ejection openings in the b area of the print head 22H. At this second scan, the first scan is performed to the print area 60-2.

Next, the print medium 1 is conveyed in a sub scan direction by a length of ¼ of the print head. Thereafter, in a third scan, based upon ejection data at the third scan to the print area 60-1, ink is ejected from the ejection openings in the C area of the print heads 22C and 22M and a treatment liquid is ejected from the ejection openings in the c area of the print head 22H. At this third scan, the second scan is performed to the print area 60-2 and the first scan is performed to the print area 60-3. The application of the treatment liquid to the print area 60-1 is completed by the first scan to the third scan. Next, the print medium 1 is conveyed in a sub scan direction by a length of ¼ of the print head. Thereafter, in a fourth scan, based upon ejection data at the fourth scan to the print area 60-1, ink is ejected from the ejection openings in the D area of the print heads 22C and 22M. At this fourth scan, the third scan is performed to the print area 60-2, the second scan is performed to the print area 60-3 and the first scan is performed to the print area 60-9. The print of the image of the ink to the print area 60-1 is thus completed by the first scan to the fourth scan. Hereinafter, by repeating the similar scans, the print of the image and the application of the treatment liquid to the print areas 60-2, 60-3 and so on will be sequentially completed.

### [Relation Between First and Second Print Systems]

FIG. 27 is an explanatory view showing a relation between the first print operation and the second print operation. In the first print operation at the left side in FIG. 27, for performing a print using 1024 pieces of the ejection openings corresponding to ⅘ widths of the print head, the ejection data of the color ink in each color and the treatment liquid are divided into each ⅕ widths of the print head (ejection openings of 256 pieces each). On the other hand, in the second print operation at the right side in FIG. 27, for performing a print using 1280 pieces of the ejection openings corresponding to the entire area of the print head, the ejection data of the color ink in each color and the treatment liquid are re-divided into each ¼ widths of the print head (ejection openings of 320 pieces each). The changing unit 37 performs this change to all the ejection data and sends the changed ejection data to the image output unit 30 as the print data. In the present embodiment as described above, in a case where the ejection data for ejecting the treatment liquid at the first scan ejecting only the treatment liquid in the first printing system does not exist, the print operation is changed to the second print operation. That is, the ejection data of the treatment liquid at the first scan in the first printing system is eliminated, the print width corresponding to one scan is changed, and the ejection opening range used in the print head is expanded to form an image by four times of the scans. In consequence, by expanding a range of the nozzles used in the print head, durability of the nozzle can be further improved. In addition, in the first print operation, when the data amount of the ejection data of the treatment liquid at the first scan is “0” or less than the predetermined amount, the print speed can be increased by changing the printing system to the second print operation. That is, in the second print operation, the first scan for ejecting the treatment liquid in the first print operation is eliminated to increase the print area per one scan. Therefore, the number of times of scans required for printing an image on a print area in a predetermined unit can be reduced. This changing timing can be set based upon at least one of a page unit of the print medium, a print job unit, changing timing of the kind of the print medium and a position of a margin part of the print medium on which an image is not formed. In addition, in a case where the ejection data of the treatment liquid at the first scan in the first print operation exists by an amount less than a predetermined amount, the ejection data may be eliminated or besides, may be added to the ejection data of the treatment liquid at one later scan than the first scan.

### 4. Other Embodiment

The above respective embodiments have explained an example where the ejection opening of the print head for ejecting the ink and the ejection opening of the print head for ejecting the treatment liquid are arranged to be at the same position in the direction (for example, sub scan direction) crossing to the main scan direction. However, it may be possible to use the print head in which the ejection opening for ejecting the ink and the ejection opening for ejecting the treatment liquid are arranged to be shifted in the direction (for example, sub scan direction) crossing to the main scan direction. In addition, the present invention may be applied to a case where the number of the ejection openings for treatment liquid is greater than the number of the ejection openings for color ink and the ejection opening array for treatment liquid is longer than the ejection opening array for ink. Further, the present invention may be applied to a case where the ejection opening array for ink is longer than the ejection opening array for treatment liquid.

The first embodiment shows a case where the ejection timing of the treatment liquid is divided into each timings of the first scan, the second scan, the third scan and the fourth scan. In the second embodiment, the ejection timing of the treatment liquid is divided into each timings of the initial scan (first scan) and the next scan (second scan). In a unit area of one pixel, plural pixels or the like, the treatment liquid may be ejected in the unit area where an image formation starts to be made, before the image formation by ink starts to be made. Accordingly the division number or the division method in the ejection timing of the treatment liquid is not limited to the aforementioned embodiments. For example, the treatment liquid may be ejected separately at the initial scan (first scan) and the subsequent third scan. Further, the treatment liquid is not necessarily ejected before image formation in regard to all the unit areas constituting the image, and in regard to a part of all the unit areas, the treatment liquid may be ejected after the image formation starts to be made.

In addition, the first embodiment and the second embodiment are configured such that the treatment liquid is not ejected in regard to the pixels (margin part) where the ejection data of ink are not present. However, in a case where the treatment liquid is ejected also in regard to the pixels where the ejection data of color ink are not present (margin part), the effect of improving an image quality such as a blur or a feathering phenomenon can be obtained to the ink adjacent to the ejected treatment liquid. Therefore, in regard to the pixels (margin part) where the ejection data of the ink are not present, presence/absence of the treatment liquid application or the division number and the division method of the ejection timing are not limited.

In each of the above embodiments, the treatment liquid is ejected at the scan before the scan at which the image formation by the ink starts. However, as long as the treatment liquid is ejected before the image formation by the ink starts, the treatment liquid may be ejected at the same scan for starting the image formation. In this case, since the print head used in the aforementioned embodiment (FIG. 2) is provided with one line as the ejection opening array for ejecting the treatment liquid, the ejection of the treatment liquid can be made at the same scan at a one-way direction (arrow X1 direction) of the two-way print. In addition, in a case where the print head has both ends provided with ejection opening arrays for ejecting the treatment liquid, by changing the ejection opening array of the treatment liquid depending on the print direction, the treatment liquid can be ejected before ejecting the ink at the same scan in any direction of the both-way print.

The present invention may be widely applied to various inkjet printers where formation of an image by color ink and application of a treatment liquid are preformed in a unit area on a print medium by plural times of scans of the print head capable of ejecting the ink and the treatment liquid. Accordingly the configuration and the arrangement number of the print head are not limited to the aforementioned embodiments only.

In addition, the present invention may eject the treatment liquid at the scan before ejecting the ink to the unit area, wherein the scan number in ejecting the treatment liquid may be set as needed.

Further, in the above first embodiment, the treatment liquid is applied at the scan (earlier scan by one scan) immediately before the scan where the ink is ejected. In the second embodiment, the treatment liquid is applied at the scan (first scan) immediately before the scan where the ink is ejected and at the second scan corresponding to the application of the ink by the third, fourth and fifth scans where the ink is ejected. However, it is possible to determine as needed by what scan number the treatment liquid is applied at the earlier scan than the scan where the ink is applied, based upon permeation characteristics (permeation time) of the treatment liquid into the print head. In addition, the print head may eject one kind of ink as ink for forming an image.

In addition, the unit area is not limited to the area corresponding to the dot formed on the print medium by ink and another area may be set.

In the aforementioned embodiment, in addition to the color ink used for image formation, the treatment liquid for improving the image performance by the color ink is prepared separately for application. Therefore, since the treatment liquid itself is not used for forming the image, it is preferably close to a colorless and transparent liquid. Even if the colored liquid is used, the component thereof for improving the image performance is added to a part or all of light ink such as light cyan ink, light magenta ink and light gray ink, so that the colored ink may act as having both functions of image formation and an increase in image performance. In this case, since it is not necessary to provide the ink tank and the print head for treatment liquid, elimination in the number of components is possible, contributing greatly to a decrease in size and low costs of the apparatus. Further, a part or all of deep color ink of the color ink used for image formation may act as the treatment liquid.

The aforementioned embodiment explains the configuration where the image processing unit 29 executing the characteristic processing of the present invention is provided in the inkjet printer, but the image processing unit 29 is not necessarily provided in the inkjet printer. For example, as shown in FIG. 24, the printer driver of the host computer connected to the inkjet printer may act as the image processing unit 29. In this case, the printer driver is configured to generate the color ink ejection data and the treatment liquid ejection data based upon the multi-valued image data received from the application and supply these data to the printer 301. In this way, an inkjet printing system configured to include the host computer and the inkjet printer 301 is also in the scope of the present invention. In this case, the host computer acts as a data supplying apparatus for supplying data to the inkjet printer and acts also as a control apparatus for controlling the inkjet printer.

The feature of the present invention is the data processing executed in the image processing unit 29. In consequence, the data generating apparatus provided with the image processing unit 29 executing the characteristic data processing of the present invention is also in the scope of the present invention. In a case where the image processing unit 29 is provided in the inkjet printer, the inkjet printer acts as the data generating apparatus of the present invention, and in a case where the image processing unit 29 is provided in the host computer, the host computer acts as the data generating apparatus of the present invention.

Further, a computer program executing the above characteristic data processing by a computer or a print medium storing the program to be readable by a computer is also in the scope of the present invention.

In addition, the present invention may be applied to various types of printers using a print medium such as paper, cloth, non-woven cloth or OHP film, and examples of a specific application apparatus may include an office machine such as a printer, a copier or a facsimile, and a mass-production machine.

Aspects of the present invention can also be realized by a computer of a system or apparatus (or devices such as a CPU or MPU) that reads out and executes a program recorded on a memory device to perform the functions of the above-described embodiment (s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-151072, filed Jun. 25, 2009, which is hereby incorporated by reference herein in its entirety.

What is claimed is:

1. An inkjet printer in which a print head ejecting ink and a treatment liquid is used, the print head scans a unit area on the print medium by plural times, the ink is ejected to the unit area based upon ink ejection data and the treatment liquid is ejected to the unit area based upon the treatment liquid ejection data, thus performing formation of an image, the inkjet printer comprising:
a treatment liquid ejection data generating unit configured to generate the treatment liquid ejection data for ejecting the treatment liquid from the print head to the unit area before the formation of the image by the ink starts,
wherein the treatment liquid ejection data generating unit generates the treatment liquid ejection data in such a manner as to eject the treatment liquid at the plural times of the scans of the print head.

2. An inkjet printer according to claim 1,
wherein the treatment liquid ejection data generating unit specifies a scan where the ink is first ejected for each unit area based upon the ink ejection data and generates the treatment liquid ejection data in such a manner as to eject the treatment liquid at a scan before the specified scan.

3. An inkjet printer according to claim 1,
wherein the treatment liquid ejection data generating unit uses a first mask pattern determined to eject the ink in the unit area by a predetermined scan of the print head to generate the treatment liquid ejection data.

4. An inkjet printer according to claim 1,
wherein the treatment liquid ejection data generating unit thins out the treatment liquid ejection data corresponding to an area composed of the plural unit areas by a predetermined ratio.

5. An inkjet printer according to claim 2,
wherein the treatment liquid ejection data generating unit generates the treatment liquid ejection data to eject the treatment liquid at an earlier scan by a predetermined scan number than the specified scan.

6. An inkjet printer according to claim 2,
wherein the treatment liquid ejection data generating unit generates the treatment liquid ejection data to eject the treatment liquid at a scan immediately before the specified scan.

7. An inkjet printer according to claim 1,
wherein the treatment liquid ejection data generating unit generates the treatment liquid ejection data in such a manner as to eject the treatment liquid at twice or more times of scans including the first scan.

8. An inkjet printer according to claim 1, further comprising:
control unit for changing a use range of an ejection opening array of the print head used for the image formation by the ink and the treatment liquid per one scan of the print head, corresponding to the treatment liquid ejection data at the first scan where only the treatment liquid is ejected among the treatment liquid ejection data generated by the generating unit,
wherein the generating unit generates a treatment liquid ejection data which differs corresponding to the change of the control unit.

9. An inkjet printer according to claim 8,
wherein the control unit expands the use range of the ejection opening array of the print head used for the image formation by the ink and the treatment liquid per one scan of the print head when an amount of the treatment liquid ejection data at the first scan where only the treatment liquid is ejected is less than a predetermined amount.

10. An inkjet printer according to claim 9,
wherein the amount of the treatment liquid ejection data corresponds to the ejection number per a unit area of the treatment liquid.

11. An inkjet printer according to claim 8,
wherein the control unit defines changing timing of the use range of the ejection opening array based upon at least one of a page unit of the print medium, a print job unit, changing timing of the kind of the print medium and a position of a margin part of the print medium where the image is not formed.

12. An inkjet printer according to claim 1,
wherein the treatment liquid ejection data generating unit generates the treatment liquid ejection data in such a manner as to eject the treatment liquid at least one scan among the plural times of the scans in regard to the unit area where the image by the ink is not formed.

13. An inkjet printer according to claim 1,
wherein the treatment liquid ejection data generating unit generates the treatment liquid ejection data in such a manner as to eject the treatment liquid at the first scan among the plural times of the scans in regard to the unit area where the image by the ink is not formed.

14. An inkjet printer according to claim 1,
wherein the print head ejects plural different kinds of ink as the ink.

15. An inkjet printer according to claim 1,
wherein the unit area is a pixel on the print medium.

16. An inkjet printer according to claim 1,
wherein the treatment liquid contains a component for coagulating the ink on a surface of the print medium at the contacting with the ink.

17. An inkjet printer according to claim 1,
wherein the treatment liquid is a colored liquid or thinner than the color of the ink

18. An inkjet printing method that a print head ejecting ink and a treatment liquid is used, the print head scans a unit area on the print medium by plural times, the ink is ejected to the unit area based upon ink ejection data and the treatment liquid is ejected to the unit area based upon the treatment liquid ejection data, thus performing formation of an image, the inkjet printing method comprising:
a treatment liquid ejection data generating step of generating the treatment liquid ejection data for ejecting the treatment liquid from the print head to the unit area before the formation of the image by the ink starts,
wherein the treatment liquid ejection data generating step generates the treatment liquid ejection data in such a manner as to eject the treatment liquid at the plural times of the scans of the print head.

19. A program for executing the treatment liquid ejection generating step in the inkjet printing method according to claim 18 by a computer.
